(19) United States
(12) Patent Application Publication
(10) Pub. No.: US 2005/0275301 A1
(43) Pub. Date: Dec. 15, 2005

(54) Electric motor

(76) Inventors: Kazumitsu Moriya, Kosai-shi (JP); Masayuki Kuwano, Kosai-shi (JP); Toshio Yamamoto, Kosai-shi (JP); Yoshiki Nakano, Hamamatsu-shi (JP); Yasuhide Ito, Shizuoka-ken (JP)

Correspondence Address: FAY KAPLUN & MARCIN, LLP, 15O BROADWAY, SUITE 702, NEW YORK, NY, 10038, US

(21) Appl. No.: 11/153,713

(22) Filed: Jun. 15, 2005

(30) Foreign Application Priority Data
Jun. 15, 2004 (JP) 2004-177280

(51) Int. Cl. H02K 21/12; H02K 37/00

(52) U.S. Cl. 310/156.45

(57) ABSTRACT

An electric motor includes a cylindrical yoke main body and a plurality of permanent magnets having an arcuate cross-section. The permanent magnets are secured to a inner circumferential surface of the yoke main body such that the permanent magnets are continuous with one another along the entire circumference of the yoke main body, thereby forming a ring. An even number of magnetic poles are formed in the permanent magnets at predetermined angular intervals along the circumferential direction of the yoke main body. A pair of the magnetic poles that are adjacent to each other in the circumferential direction of the yoke main body have different magnetic polarities from each other. At least one of the permanent magnets is provided with a section where the magnetic polarity changes in the circumferential direction of the yoke main body. This suppresses vibration excited in a stator that causes vibration and noise.

### FIELD OF THE INVENTION

The present invention relates to an electric motor.

### BACKGROUND OF INFORMATION

A typical direct current electric motor disclosed in, for example, Japanese Laid-Open Patent Publication No. 2003-299269 includes a stator and an armature (rotor). The stator includes a yoke main body and an even number of magnetic poles located on the yoke main body. The armature includes an armature core around which a number of armature coils are wound and a commutator against which brushes slide. Such a direct current electric motor generates rotational force through rectification effect of the armature.

The direct current electric motor may generate noise and vibration due to resonance caused by the natural vibration of the stator. That is, the natural vibration of the stator is excited by the rotational force of the motor, thereby causing the stator to resonate. As a result, the direct current electric motor may generate noise and vibration.

FIGS. 11(a) to 11(c) are schematic diagrams showing examples of natural vibration modes of a cylindrical stator (a yoke main body). As shown in the figures, the natural vibration modes of the cylindrical stator include even numbers of nodes and antinodes. That is, a second natural vibration mode shown in FIG. 11(a) includes four nodes arranged at angular intervals of 90° and four antinodes each of which arranged at the middle of the adjacent nodes. A third natural vibration mode shown in FIG. 11(b) includes six nodes arranged at angular intervals of 60° and six antinodes each of which is arranged at the middle of the adjacent nodes. A fourth natural vibration mode shown in FIG. 11(c) includes eight nodes arranged at angular intervals of 45° and eight antinodes each of which is arranged at the middle of the adjacent nodes.

FIGS. 12(a) to 12(c) are schematic diagrams for explaining the relationship between the arrangement of permanent magnets and vibration generated on the stator. Arrows shown in FIGS. 12(a) to 12(c) show the directions of the vibration. An even number of the permanent magnets are secured to the yoke main body along the circumferential direction of the yoke main body at predetermined angular intervals. The polarities of the magnetic poles of the adjacent permanent magnets along the circumferential direction of the yoke main body are different from each other. FIG. 12(a) shows a two-pole electric motor including two permanent magnets 81, 82. In this case, the vibration having two nodes and two antinodes is excited in the stator. Each node is arranged at the center of one of the permanent magnets 81, 82 in the circumferential direction of the yoke main body. Each antinode is arranged at the middle of the ends of the adjacent permanent magnets 81, 82. The vibration is excited due to the following two factors. One factor is that the rigidity of sections of the stator between the ends of the adjacent permanent magnets 81, 82 is lower than the rigidity of sections of the stator at which the permanent magnets 81, 82 are arranged. The other factor is the magnetic function caused by rotation of the electric motor at the middle of the ends of the adjacent permanent magnets 81, 82, that is, at sections where the magnetic polarity is changed. FIG. 12(b) shows a four-pole electric motor including four permanent magnets 83 to 86. In this case, a vibration including four nodes and four antinodes is excited in the stator. FIG. 12(c) shows a six-pole electric motor including six permanent magnets 87 to 92. In this case, a vibration including six nodes and six antinodes is excited in the stator.

The arrangement of the nodes and the antinodes of FIG. 12(b) coincides that of the second natural vibration mode shown in FIG. 11(a). Therefore, in the electric motor of FIG. 12(b), the natural vibration of the stator is excited in the second natural vibration mode, which causes the resonance of the stator. On the other hand, the arrangement of the nodes and the antinodes of FIG. 12(c) coincides the third natural vibration mode shown in FIG. 11(b). Therefore, in the electric motor of FIG. 12(c), the natural vibration of the stator is excited in the third natural vibration mode, which causes the resonance of the stator. As described above, the resonance of the stator caused in this manner is one of the causes of the vibration and noise of the electric motor.

### SUMMARY OF THE INVENTION

Accordingly, the present invention relates to an electric motor that suppresses vibration excited in a stator that causes vibration and noise.

An exemplary embodiment of the present invention relates to an electric motor including a cylindrical yoke main body and a plurality of permanent magnets. The permanent magnets have an arcuate cross-section, and are secured to a circumferential surface of the yoke main body such that the permanent magnets are continuous with one another along the entire circumference of the yoke main body, thereby forming a ring. An even number of magnetic poles are formed in the permanent magnets at predetermined angular intervals along the circumferential direction of the yoke main body. A pair of the magnetic poles that are adjacent to each other in the circumferential direction of the yoke main body have different magnetic polarities from each other. At least one of the permanent magnets is provided with a section where the magnetic polarity changes in the circumferential direction of the yoke main body.

The present invention provides another electric motor including a cylindrical yoke main body and a plurality of permanent magnets. The plurality of permanent magnets have an arcuate cross-section, and are secured to a circumferential surface of the yoke main body such that the permanent magnets are continuous with one another along the entire circumference of the yoke main body, thereby forming a ring. The magnetic polarity of the middle section of each permanent magnet in the circumferential direction of the yoke main body differs from the magnetic polarity of the end sections of the permanent magnet in the circumferential direction of the yoke main body.

Further, the present invetion provides another electric motor including a cylindrical yoke main body and an odd number of permanent magnets the number of which is greater than or equal to three. The permanent magnets have an arcuate cross-section, and are secured to a circumferential surface of the yoke main body such that the permanent magnets are continuous with one another along the entire circumference of the yoke main body, thereby forming a ring. The lengths of the permanent magnets in the circumferential direction of the yoke main body are equal to one another. Even numbers of magnetic poles are formed in the permanent magnets along the circumferential direction of the yoke main body at predetermined angular intervals from one another. A pair of the magnetic poles that are adjacent to each other in the circumferential direction of the yoke main body have different magnetic polarities from each other.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagrammatic view illustrating a direct current electric motor according to a first embodiment of the present invention;

FIG. 2 is an expanded view of the direct current electric motor shown in FIG. 1;

FIG. 3(a) is a schematic diagram illustrating the stator of the direct current electric motor shown in FIG. 1 for showing the arrangement of the magnetic poles with respect to the permanent magnets;

FIG. 3(b) is a schematic diagram illustrating the permanent magnets of the direct current electric motor shown in FIG. 1 for explaining the vibration excited in the stator;

FIG. 4(a) is a schematic diagram illustrating a stator of a direct current electric motor according to a second embodiment of the present invention for showing the arrangement of magnetic poles with respect to permanent magnets;

FIG. 4(b) is a schematic diagram showing the permanent magnets of the direct current electric motor of the second embodiment for explaining the vibration excited in the stator;

FIG. 5(a) is a schematic diagram illustrating a stator of a direct current electric motor according to a third embodiment of the present invention for showing the arrangement of magnetic poles with respect to permanent magnets;

FIG. 5(b) is a schematic diagram illustrating the permanent magnets of the direct current electric motor of the third embodiment for explaining the vibration excited in the stator;

FIG. 6 is a schematic diagram illustrating a stator of a direct current electric motor according to a fourth embodiment of the present invention for showing the arrangement of magnetic poles with respect to permanent magnets;

FIG. 7(a) is an expanded view illustrating a stator of a direct current electric motor according to a fifth embodiment of the present invention for showing the arrangement of permanent magnets;

FIG. 7(b) is an expanded view illustrating the stator of the direct current electric motor of the fifth embodiment showing the arrangement of magnetic poles formed in the permanent magnets;

FIG. 8(a) is a schematic diagram illustrating a stator of a direct current electric motor according to a sixth embodiment of the present invention for showing the arrangement of magnetic poles with respect to permanent magnets;

FIG. 8(b) is an expanded view illustrating the stator of the direct current electric motor of the sixth embodiment showing the arrangement of the magnetic poles with respect to the permanent magnets;

FIG. 9(a) is an expanded view illustrating a stator of a direct current electric motor according to a modified embodiment of the present invention for showing the arrangement of permanent magnets;

FIGS. 9(b) to 9(e) are expanded views illustrating the stator of the direct current electric motor of the modified embodiment for showing the arrangement of magnetic poles formed in the permanent magnets;

FIG. 10 is an expanded view illustrating a stator of a direct current electric motor according to another modified embodiment of the present invention showing the arrangement of magnetic poles with respect to permanent magnets;

FIGS. 11(a) to 11(c) are schematic diagrams for explaining the natural vibration modes of the cylindrical yoke main body; and

FIGS. 12(a) to 12(c) are schematic diagrams for explaining the relationship between the arrangement of the permanent magnets and the vibration generated in the stator.

### DETAILED DESCRIPTION OF THE PREFERRED EMBODIMENTS

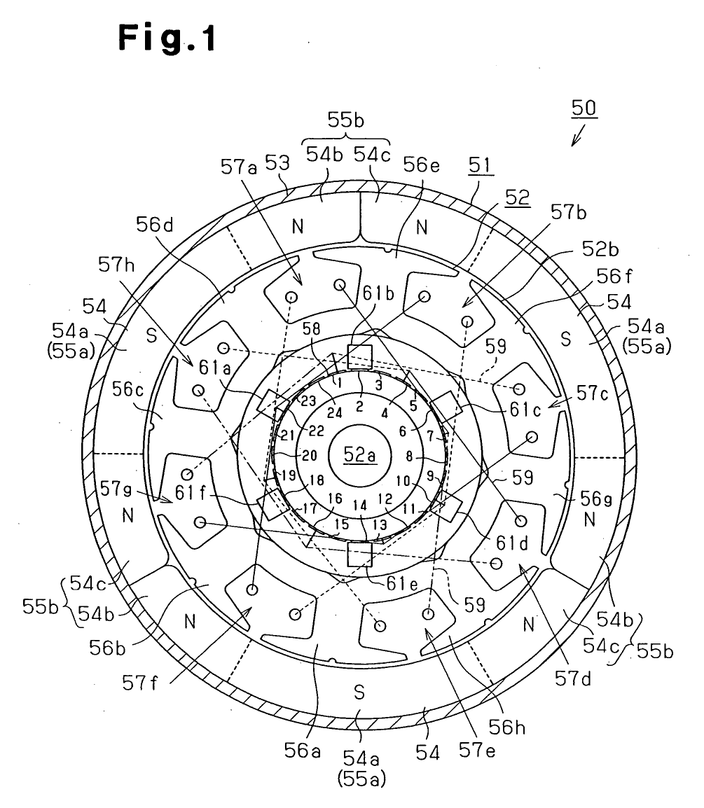

A first exemplary embodiment of the present invention will now be described with reference to FIGS. 1 to 3(b).

FIG. 1 is a diagrammatic view of a direct current electric motor 50 according to the first embodiment. As shown in FIG. 1, the direct current electric motor 50 includes a stator 51 and a rotor, which is an armature 52 in the first embodiment. The stator 51 includes a cylindrical yoke main body 53 and three permanent magnets 54 secured to the inner circumferential surface of the yoke main body 53.

Each permanent magnet 54 has an arcuate cross-section. The lengths of the permanent magnets 54 in the circumferential direction of the yoke main body 53 are equal to one another. The permanent magnets 54 are secured to the inner circumferential surface of the yoke main body 53 such that the permanent magnets 54 lie continuously along the entire circumference of the yoke main body 53, thereby forming a ring. Therefore, the permanent magnets 54 are arranged at intervals of 120° along the circumferential direction of the yoke main body 53.

The magnetic polarity of the middle section of each permanent magnet 54 in the circumferential direction of the yoke main body 53 is different from that of the end sections of the permanent magnet 54 in the circumferential direction of the yoke main body 53. More specifically, the middle section of each permanent magnet 54 in the circumferential direction of the yoke main body 53 forms a first polarized portion 54a having the characteristics of the south (S) pole. The end sections of each permanent magnet 54 in the circumferential direction of the yoke main body 53 form second polarized portions 54b, 54c having the characteristics of the north (N) pole. Therefore, as shown in FIG. 1, the permanent magnets 54 include three S magnetic poles 55a, which include the first polarized portions 54a, and three N magnetic poles 55b, which include the second polarized portions 54b, 54c.

The length of each of the second polarized portions 54b, 54c in the circumferential direction of the yoke main body 53 is half the length of each first polarized portion 54a in the circumferential direction of the yoke main body 53. Since the angular dimension of each permanent magnet 54 in the circumferential direction of the yoke main body 53 is 120°, the angular dimension of each first polarized portion 54a in the circumferential direction of the yoke main body 53 is 60°, and the angular dimension of each of the second polarized portions 54b, 54c in the circumferential direction of the yoke main body 53 is 30°. Therefore, the magnetic poles 55a, 55b are arranged at intervals of 60° along the circumferential direction of the yoke main body 53. In this regard, however, a pair of the magnetic poles 55a, 55b adjacent to each other in the circumferential direction of the yoke main body 53 have different polarity from each other. In other words, the S magnetic poles 55a and the N magnetic poles 55b are arranged alternately in the circumferential direction of the yoke main body 53. The thicknesses of the magnetic poles 55a, 55b in the radial direction of the yoke main body 53, that is, the thicknesses of the permanent magnets 54 in the radial direction of the yoke main body 53 are equal to one another. The magnetic flux densities of the magnetic poles 55a, 55b are also equal to one another. In this manner, the stator 51 includes the six magnetic poles 55a, 55b that are arranged alternately such that the polarity changes at intervals of 60° along the circumferential direction of the yoke main body 53. Since the magnetic poles 55a, 55b are arranged as described above, each permanent magnet 54 has two sections where the magnetic polarity changes. In other words, each permanent magnet 54 includes sections that have different magnetic polarities from each other and that are adjacent to each other in the circumferential direction of the yoke main body 53. Furthermore, each boundary surface between a pair of the permanent magnets 54 that are adjacent to each other in the circumferential direction of the yoke main body 53 is located in a corresponding one of the magnetic poles 55b.

The armature 52 is rotatably arranged on the inner side of the permanent magnets 54. The armature 52 has a rotary shaft 52a. An armature core 52b is secured to the rotary shaft 52a. The core 52b has eight teeth, or first to eighth teeth 56a to 56h. First to eighth slots 57a to 57h are each formed between a pair of the teeth 56a to 56h that are adjacent to each other in the circumferential direction of the yoke main body 53. In FIG. 1, the first to eighth teeth 56a to 56h and the first to eighth slots 57a to 57h are arranged clockwise, and the first slot 57a is located between the fourth tooth 56d and the fifth tooth 56e.

The armature 52 further has a commutator 58. The commutator 58 has twenty-four segments, or first to twenty-fourth segments 1 to 24. The segments 1 to 24 are arranged at equal angular intervals along the circumferential direction of the rotary shaft 52a. The first to twenty-fourth segments 1 to 24 are arranged clockwise as viewed in FIG. 1. The first segment 1 is located corresponding to the middle position of the first slot 57a in the circumferential direction of the yoke main body 53. In other words, the first segment 1 is located corresponding to the middle position between the fourth tooth 56d and the fifth tooth 56e.

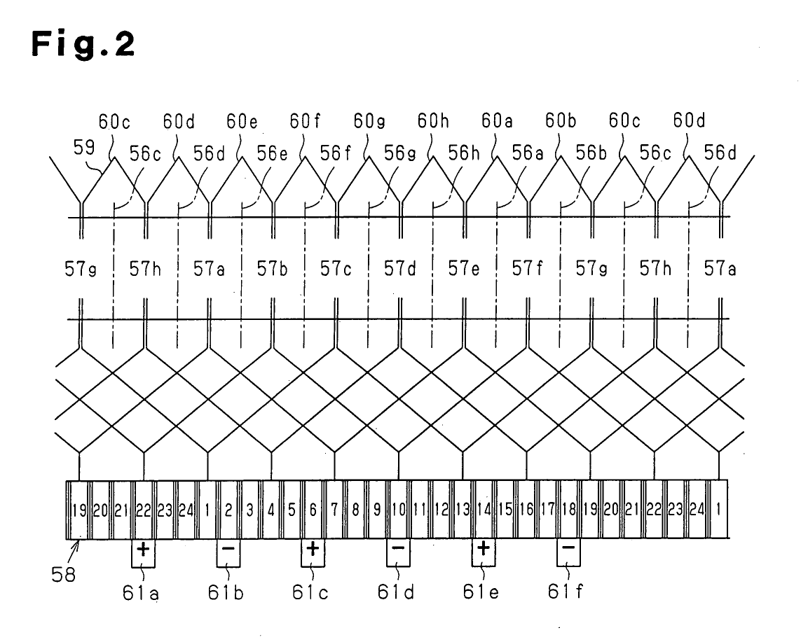

As shown in FIGS. 1 and 2, a wire 59 is first connected to the first segment 1 and is wound about the sixth tooth 56f between the third slot 57c and the second slot 57b by a predetermined number of turns, which is then connected to the tenth segment 10. After being connected to the tenth segment 10, the wire 59 is wound about the first tooth 56a located between the sixth slot 57f and the fifth slot 57e by a predetermined number of turns, which is then connected to the nineteenth segment 19. After being connected to the nineteenth segment 19, the wire 59 is wound about the fourth tooth 56d located between the first slot 57a and the eighth slot 57h by a predetermined number of turns, which is then connected to the fourth segment 4. FIG. 1 shows part of the wire 59 from where the wire 59 is connected to the first segment 1 to where the wire 59 is connected to the fourth segment 4 with a broken line.

After being connected to the fourth segment 4, the wire 59 is wound about the seventh tooth 56g located between the fourth slot 57d and the third slot 57c by a predetermined number of turns, which is then connected to the thirteenth segment 13. After being connected to the thirteenth segment 13, the wire 59 is wound about the second tooth 56b located between the seventh slot 57g and the sixth slot 57f by a predetermined number of turns, which is then connected to the twenty-second segment 22. After being connected to the twenty-second segment 22, the wire 59 is wound about the fifth tooth 56e located between the second slot 57b and the first slot 57a by a predetermined number of turns, which is then connected to the seventh segment 7. FIG. 1 shows part of the wire 59 from where the wire 59 is connected to the fourth segment 4 to where the wire 59 is connected to the seventh segment 7 with a solid line.

After being connected to the seventh segment 7, the wire 59 is connected to the eighth tooth 56h located between the fifth slot 57e and the fourth slot 57d by a predetermined number of turns, which is then connected to the sixteenth segment 16. After being connected to the sixteenth segment 16, the wire 59 is wound about the third tooth 56c located between the eighth slot 57h and the seventh slot 57g by a predetermined number of turns, which is then connected to the first segment 1. In this manner, winding of the wire 59 is completed. FIG. 1 shows part of the wire 59 from where the wire 59 is connected to the seventh segment 7 and to where the wire 59 is connected to the first segment 1 with a chain double-dashed line.

In other words, in the first embodiment, the wire 59 is connected to every third segments 1, 4, 7, 10, 13, 16, 19, 22 among the first to twenty-fourth segments 1 to 24. Connection to the segments 1, 4, 7, 10, 13, 16, 19, 22 and winding to the teeth 56a to 56h are alternately repeated, thereby forming eight armature coils, or first to eighth coils 60a to 60h. That is, the direct current electric motor 50 of the first embodiment is configured by six poles, eight coils, and twenty four segments. In the first embodiment, the wire 59 is wound about the teeth 56a to 56h through concentrated winding.

Six brushes held by a brush holder, which is not shown, or first to sixth brushes 61a to 61f slide against the commutator 58. The brushes 61a to 61f are arranged at intervals of 60° along the circumferential direction of the yoke main body 53 such that the center line of each of the brushes 61a to 61f along the circumferential direction of the yoke main body 53 is aligned with the center point of a corresponding one of the magnetic poles 55a, 55b along the circumferential direction of the yoke main body 53. The first to sixth brushes 61a to 61f are arranged clockwise as viewed in FIG. 1. The first, third, and fifth brushes 61a, 61c, and 61e are anode(positive) brushes, and the second, fourth, and sixth brushes 61b, 61d, and 61f are cathode (negative) brushes. The armature 52 of the direct current electric motor 50 is rotated when drive current is supplied through the commutator 58 using the brushes 61a to 61f.

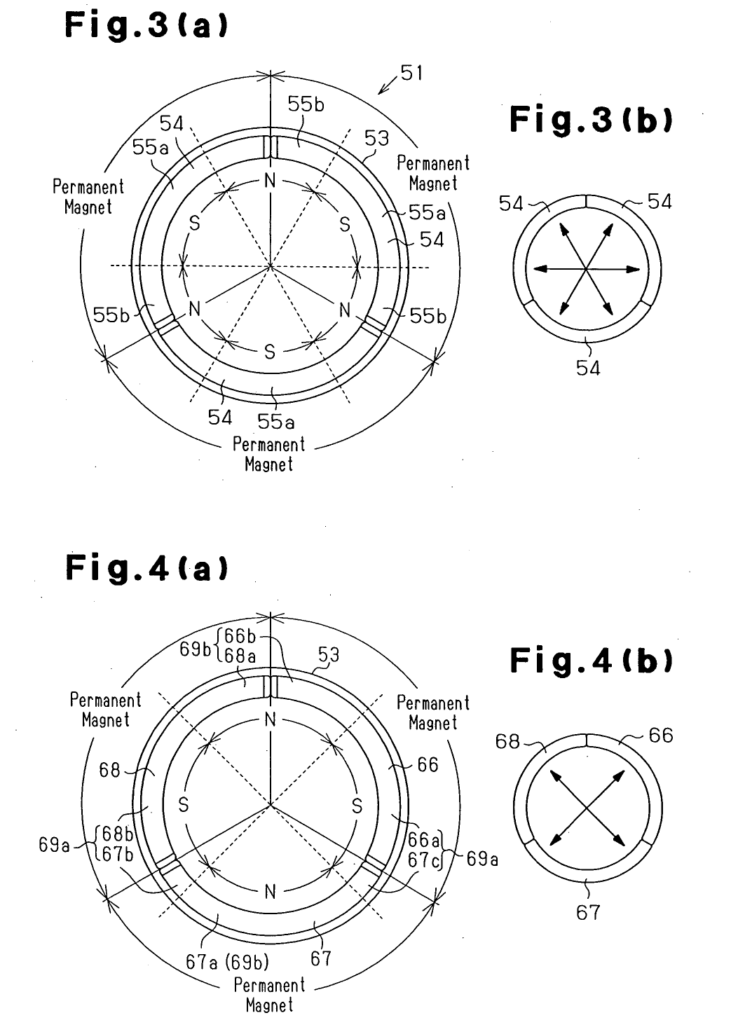

Next, the operations of the direct current electric motor 50 shown in FIG. 1, that is, vibration of the stator 51 that accompanies the rotation of the armature 52 will now be described with reference to FIGS. 3(a) and 3(b). FIG. 3(a) is a schematic diagram of the stator 51 showing the arrangement of the magnetic poles 55a, 55b with respect to the permanent magnets 54. In the drawing, among the straight-line segments that extend in the radial direction of the yoke main body 53, the straight-line segments each passing through the boundary surface between a pair of the permanent magnets 54 that are adjacent to each other in the circumferential direction of the yoke main body 53 are indicated by solid lines, and the straight-line segments each passing through the boundary surface (the section where the magnetic polarity changes) between a pair of magnetic poles 55a, 55b that are adjacent to each other in the circumferential direction of the yoke main body 53 are indicated by broken lines. FIG. 3(b) is a schematic diagram of the permanent magnets 54 for explaining the vibration excited in the stator 51. In FIG. 3(b), arrows indicate the directions of the vibration of the stator 51.

As shown in FIG. 3(a), each permanent magnet 54 includes sections that have different magnetic polarities from each other and that are adjacent to each other in the circumferential direction of the yoke main body 53. In other words, each boundary surface (the section where the magnetic polarity changes) between a pair of the magnetic poles 55a, 55b that are adjacent to each other in the circumferential direction of the yoke main body 53 is located in a corresponding one of the permanent magnets 54. In addition, each boundary surface between a pair of the permanent magnets 54 that are adjacent to each other in the circumferential direction of the yoke main body 53 is located in a corresponding one of the magnetic poles 55b. The vibration is excited in the stator 51 as shown in FIG. 3(b) in accordance with the operation of the direct current electric motor 50, that is, rotation of the armature 52. The vibration sets, as antinodes, sections of the yoke main body 53 each corresponding to the boundary surface between a pair of the magnetic poles 55a, 55b that are adjacent to each other in the circumferential direction of the yoke main body 53, and as nodes, sections of the yoke main body 53 each corresponding to the center point of one of the magnetic poles 55a, 55b in the circumferential direction of the yoke main body 53. In the first embodiment, sections of the yoke main body 53 each corresponding to the boundary surface between a pair of the magnetic poles 55a, 55b that are adjacent to each other in the circumferential direction of the yoke main body 53 are each reinforced by the corresponding permanent magnet 54 against the antinode of the vibration excited in the stator 51. Therefore, the vibration excited in the stator 51 is suppressed.

The first embodiment provides the following advantages.

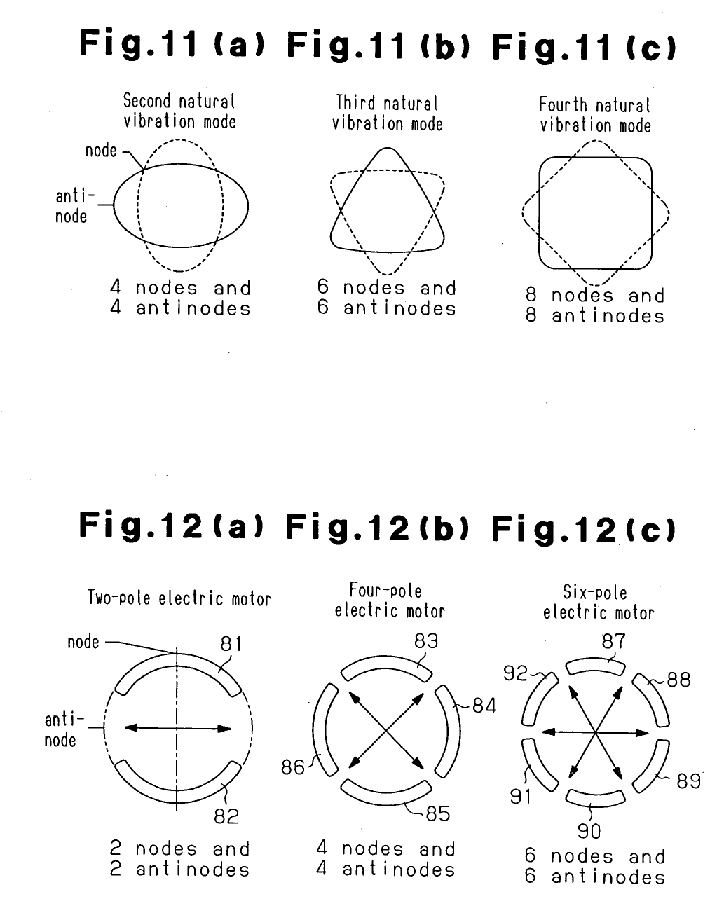

(1) Each boundary surface between a pair of the magnetic poles 55a, 55b that are adjacent to each other in the circumferential direction of the yoke main body 53 is located in a corresponding one of the permanent magnets 54, and each boundary surface between a pair of the permanent magnets 54 that are adjacent to each other in the circumferential direction of the yoke main body 53 is located in a corresponding one of the magnetic poles 55b. Therefore, sections of the stator 51 (the yoke main body 53) each corresponding to the boundary surface between a pair of the magnetic poles 55a, 55b that are adjacent to each other in the circumferential direction of the yoke main body 53 are each reinforced by the corresponding permanent magnet 54 against the antinode of the vibration excited in the stator 51 in accordance with rotation of the armature 52. Therefore, the vibration excited in the stator 51 is suppressed, thereby suppressing the resonance of the stator 51. Consequently, the noise and vibration generated in the electric motor 50 is reduced. The vibration excited in the stator 51 of the electric motor 50 shown in FIG. 1 corresponds to the third natural vibration mode shown in FIG. 11(b).

(2) The number of the permanent magnets 54 included in the electric motor 50 shown in FIG. 1 is three, which is an odd number. On the other hand, since the number of the magnetic poles 55a, 55b included in the permanent magnets 54 is six, which is an even number, the number of the sections where the magnetic polarity changes is also six, which is an even number. Therefore, at least one of the permanent magnets 54 is provided with the section where the magnetic polarity changes. Thus, the vibration excited in the stator 51 is suppressed with a very simple configuration. In particular, since the number of the permanent magnets 54 is an odd number, the number of the boundary surfaces each located between a pair of the permanent magnets 54 that are adjacent to each other in the circumferential direction of the yoke main body 53 is also an odd number. In other words, the number of sections of the yoke main body 53 where the rigidity is relatively low and that tend to become the antinodes of the vibration is also an odd number. This further suppresses the excitation of the natural vibration in the yoke main body 53 (the stator 51).

(3) The lengths of the permanent magnets 54 in the circumferential direction of the yoke main body 53 are set equal to one another. Therefore, the boundary surfaces each located between a pair of the permanent magnets 54 that are adjacent to each other in the circumferential direction of the yoke main body 53, in other words, the sections of the yoke main body 53 where the rigidity is relatively low and that tend to become the antinodes of the vibration are arranged at equal angular intervals along the circumferential direction of the yoke main body 53. Therefore, even if the vibration is excited in the stator 51, the vibration is not concentrated at one part in the circumferential direction of the stator 51, but is distributed in the circumferential direction of the stator 51.

(4) The permanent magnets 54 are abut against and secured to the inner circumferential surface of the yoke main body 53 such that the permanent magnets 54 lie continuously along the entire circumference of the yoke main body 53, thereby forming a ring. This improves the rigidity of the entire stator 51.

(5) In the first embodiment, the boundary surfaces each located between a pair of the permanent magnets 54 that are adjacent to each other in the circumferential direction of the yoke main body 53 do not coincide with any of the sections where the magnetic polarity changes. This stabilizes the variation of the magnetic flux density between the magnetic poles 55a, 55b and suppresses harmful influence of cogging, or the like.

(6) The length of each second polarized portions 54b, 54c in the circumferential direction of the yoke main body 53 is half the length of each first polarized portion 54a in the circumferential direction of the yoke main body 53. Each permanent magnet 54 is axisymmetrical with respect to a center line of the permanent magnet 54 in the circumferential direction of the yoke main body 53. Therefore, even if each permanent magnet 54 is secured to the yoke main body 53 with the polarized portions 54b, 54c being reversed, no influence is found. Thus, the permanent magnets 54 are easily installed in the yoke main body 53.

(7) Each boundary surface located between a pair of the permanent magnets 54 that are adjacent to each other in the circumferential direction of the yoke main body 53 is located at a middle point of the corresponding one of the magnetic poles 55a, 55b in the circumferential direction of the yoke main body 53. In other words, on the assumption that a corresponding one of the magnetic poles 55b is a first magnetic pole, and two magnetic poles 55a that are adjacent to the first magnetic pole in the circumferential direction of the yoke main body 53 are a second magnetic pole and a third magnetic pole, each boundary surface between a pair of the permanent magnets 54 adjacent to each other in the circumferential direction of the yoke main body 53 is located at a middle point between the boundary surface between the first magnetic pole and the second magnetic pole and the boundary surface between the first magnetic pole and the third magnetic pole. Therefore, each boundary surface between a pair of the permanent magnets 54 that are adjacent to each other in the circumferential direction of the yoke main body 53 is arranged furthest from the corresponding section where the magnetic polarity changes. More specifically, each boundary surface is arranged at intervals of 30° from the corresponding section where the magnetic polarity changes. Therefore, the vibration excited in the stator 51 is more reliably suppressed.

(8) The number of the permanent magnets 54 included in the electric motor 50 shown in FIG. 1 is a minimum odd number other than one, which is three. Therefore, the angular dimension of the permanent magnet 54 is as large as 120° in the circumferential direction of the yoke main body 53. Thus, the permanent magnets 54 further reinforce the yoke main body 53 and the vibration excited in the stator 51 is more reliably suppressed.

(9) The wire 59 is wound about the teeth 56a to 56h through the concentrated winding to form the coils 60a to 60h. Therefore, great attractive/repulsive force is likely to occur. However, according to the electric motor 50 shown in FIG. 1, the attractive/repulsive force suppresses the vibration excited in the stator 51 in a suitable manner.

A second embodiment of the present invention will now be described with reference to FIGS. 4(a) and 4(b). The direct current electric motor of the second embodiment differs from the direct current electric motor 50 of the first embodiment in that the number of the magnetic poles 55a, 55b is not six but four. The differences from the first embodiment will mainly be discussed below, and explanations of components that are like or the same as the components of the first embodiment are omitted.

FIG. 4(a) is a schematic diagram of a stator of the direct current electric motor according to the second embodiment for showing the arrangement of magnetic poles 69a, 69b with respect to permanent magnets 66, 67, 68. FIG. 4(b) is a schematic diagram of the permanent magnets 66 to 68 for explaining the vibration excited in the stator. As shown in FIG. 4(a), three permanent magnets 66 to 68 are secured to the inner circumferential surface of the yoke main body 53. The permanent magnets 66 to 68 each have an arcuate cross-section, and the lengths of the permanent magnets 66 to 68 in the circumferential direction of the yoke main body 53 are equal to one another. The permanent magnets 66 to 68 are secured to the inner circumferential surface of the yoke main body 53 such that the permanent magnets 66 to 68 lie continuously along the entire circumference of the yoke main body 53, thereby forming a ring.

The magnetic polarity of one end of the permanent magnets 66, 68 in the circumferential direction of the yoke main body 53 differs from that of the other end of the permanent magnets 66, 68 in the circumferential direction of the yoke main body 53. More specifically, one end of the permanent magnets 66, 68 in the circumferential direction of the yoke main body 53 forms first polarized portions 66a, 68b, which have the characteristics of the S pole, and the other end of the permanent magnets 66, 68 in the circumferential direction of the yoke main body 53 forms second polarized portions 66b, 68a, which have the characteristics of the N pole. The magnetic polarity of the middle section of the permanent magnet 67 in the circumferential direction of the yoke main body 53 differs from that of the end sections of the permanent magnet 67 in the circumferential direction of the yoke main body 53. More specifically, the middle section of the permanent magnet 67 in the circumferential direction of the yoke main body 53 forms a first polarized portion 67a, which has the characteristics of the N pole, and the end sections of the permanent magnet 67 in the circumferential direction of the yoke main body 53 form second polarized portions 67b, 67c, which have the characteristics of the S pole.

Therefore, as shown in FIG. 4(a), the permanent magnets 66 to 68 include the S magnetic pole 69a including the polarized portions 66a, 67c and the S magnetic pole 69a including the polarized portions 67b, 68b, and the N magnetic pole 69b including the polarized portion 67a, and the N magnetic pole 69b including the polarized portions 66b, 68a. The magnetic poles 69a, 69b are arranged at intervals of 90° along the circumferential direction of the yoke main body 53. In this regard, however, the polarities of the pair of magnetic poles 69a, 69b that are adjacent to each other in the circumferential direction of the yoke main body 53 are different from each other. In other words, the S magnetic poles 69a and the N magnetic poles 69b are arranged alternately in the circumferential direction of the yoke main body 53. The thicknesses of the magnetic poles 69a, 69b in the radial direction of the yoke main body 53, that is, the thicknesses of the permanent magnets 66 to 68 in the radial direction of the yoke main body 53 are equal to one another. In addition, the magnetic flux densities of the magnetic poles 69a, 69b are also equal to one another. As described above, the stator includes the four magnetic poles 69a, 69b of alternating polarity arranged at intervals of 90° along the circumferential direction of the yoke main body 53.

In FIG. 4(a), among the straight-line segments that extend in the radial direction of the yoke main body 53, the straight-line segments each passing through the boundary surface between a pair of the permanent magnets 66 to 68 that are adjacent to each other in the circumferential direction of the yoke main body 53 are indicated by solid lines, and the straight-line segments each passing through the boundary surface (the section where the magnetic polarity changes) between a pair of the magnetic poles 69a, 69b that are adjacent to each other in the circumferential direction of the yoke main body 53 are indicated by broken lines. As shown in FIG. 4(a), each permanent magnet 66 to 68 includes sections that have different magnetic polarities from each other and that are adjacent to each other in the circumferential direction of the yoke main body 53. In other words, each boundary surface (the section where the magnetic polarity changes) between a pair of the magnetic poles 69a, 69b that are adjacent to each other in the circumferential direction of the yoke main body 53 is located in a corresponding one of the permanent magnets 66 to 68. Also, each boundary surface between a pair of the permanent magnets 66 to 68 adjacent to each other in the circumferential direction of the yoke main body 53 is located in a corresponding one of the magnetic poles 69a, 69b. In FIG. 4(b), the arrows show the directions of the vibration of the stator. The vibration is excited in the stator as shown in FIG. 4(b) in accordance with the operation of the direct current electric motor, that is, the rotation of the armature. The vibration sets, as antinodes, sections of the yoke main body 53 corresponding to the boundary surfaces each located between a pair of the magnetic poles 69a, 69b that are adjacent to each other in the circumferential direction of the yoke main body 53, and as nodes, sections of the yoke main body 53 each corresponding to the center point of one of the magnetic poles 69a, 69b in the circumferential direction of the yoke main body 53. In the second embodiment, sections of the yoke main body 53 each corresponding to the boundary surface between a pair of the magnetic poles 69a, 69b that are adjacent to each other in the circumferential direction of the yoke main body 53 are each reinforced by a corresponding one of the permanent magnets 66 to 68 against the antinode of the vibration excited in the stator. Therefore, the vibration excited in the stator is suppressed.

The second embodiment provides the advantages that are the same as the advantages (1) to (5), (8) and (9) of the first embodiment.

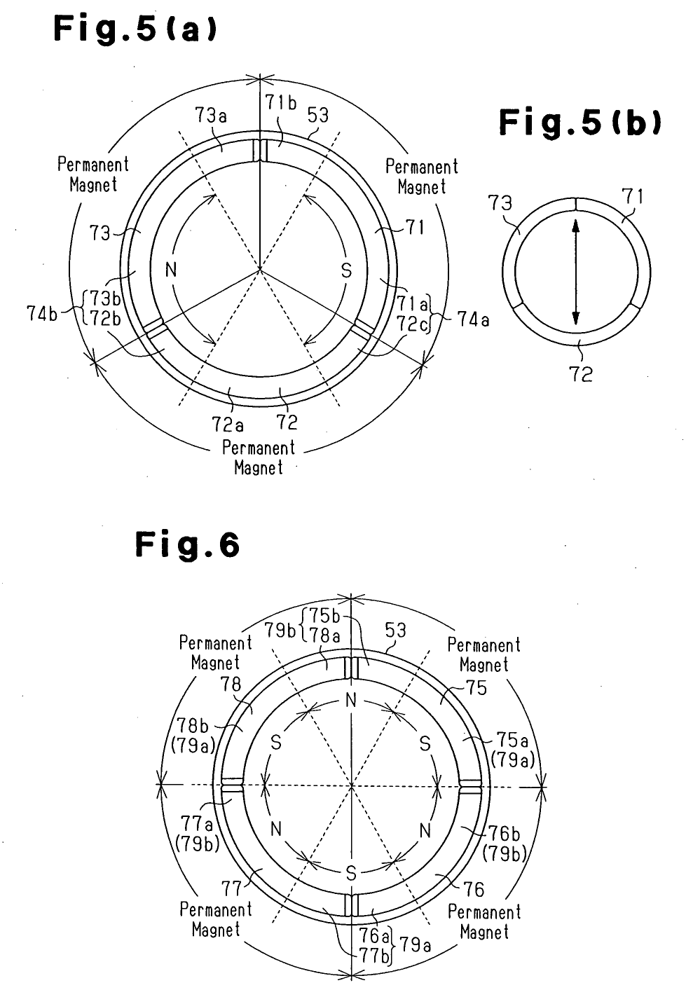

A third embodiment of the present invention will now be described with reference to FIGS. 5(a) and 5(b). A direct current electric motor of the third embodiment differs from the direct current electric motor 50 of the first embodiment in that the number of the magnetic poles is not six but two. Accordingly, differences from the first embodiment will mainly be discussed below, and explanations of components that are like or the same as the components of the first embodiment are omitted.

FIG. 5(a) is a schematic diagram of a stator of the direct current electric motor according to the third embodiment for showing the arrangement of magnetic poles 74a, 74b with respect to permanent magnets 71, 72, 73, FIG. 5(b) is a schematic diagram of the permanent magnets 71 to 73 for explaining the vibration excited in the stator. As shown in FIG. 5(a), three permanent magnets 71 to 73 are secured to the inner circumferential surface of the yoke main body 53. The permanent magnets 71 to 73 each have an arcuate cross-section, and the lengths of the permanent magnets 71 to 73 in the circumferential direction of the yoke main body 53 are equal to one another. The permanent magnets 71 to 73 are secured to the inner circumferential surface of the yoke main body 53 such that the permanent magnets 71 to 73 lie continuously along the entire circumference of the yoke main body 53, thereby forming a ring.

One end of the permanent magnet 71 in the circumferential direction of the yoke main body 53 forms a polarized portion 71a, which has the characteristics of the S pole, and the other end of the permanent magnet 71 in the circumferential direction of the yoke main body 53 forms a non-polarized portion 71b. The magnetic polarities of the ends of the permanent magnet 72 in the circumferential direction of the yoke main body 53 are different from each other. More specifically, the middle section of the permanent magnet 72 in the circumferential direction of the yoke main body 53 forms a non-polarized portion 72a. One end of the permanent magnet 72 in the circumferential direction of the yoke main body 53 forms a first polarized portion 72b, which has the characteristics of the N pole, and the other end of the permanent magnet 72 in the circumferential direction of the yoke main body 53 forms a second polarized portion 72c, which has the characteristics of the S pole. One end of the permanent magnet 73 in the circumferential direction of the yoke main body 53 forms a non-polarized portion 73a, and the other end of the permanent magnet 73 in the circumferential direction of the yoke main body 53 forms a polarized portion 73b, which has the characteristics of the N pole.

Therefore, as shown in FIG. 5(a), the permanent magnets 71 to 73 include the S magnetic pole 74a, which includes the polarized portions 71a, 72c, and the N magnetic pole 74b, which includes the polarized portions 72b, 73b. The magnetic poles 74a, 74b are arranged at intervals of 180° in the circumferential direction of the yoke main body 53. In other words, the S magnetic pole 74a and the N magnetic pole 74b are arranged opposite to each other. The thicknesses of the magnetic poles 74a, 74b in the radial direction of the yoke main body 53, that is, the thicknesses of the permanent magnets 71 to 73 in the radial direction of the yoke main body 53 are equal to one another. The magnetic flux densities of the magnetic poles 74a, 74b are also equal to each other. As described above, the stator includes the two magnetic poles 74a, 74b of alternating polarity arranged at intervals of 180° along the circumferential direction of the yoke main body 53.

In FIG. 5(a), among the straight-line segments that extend in the radial direction of the yoke main body 53, the straight-line segments each passing through the boundary surface between a pair of the permanent magnets 71 to 73 that are adjacent to each other in the circumferential direction of the yoke main body 53 are indicated by solid lines, and the straight-line segments that pass through the ends of the magnetic poles 74a, 74b in the circumferential direction of the yoke main body 53 are indicated by broken lines. As shown in FIG. 5(a), each permanent magnet 71 to 73 includes a section having magnetic polarity and a section having no magnetic polarity that are adjacent to each other in the circumferential direction of the yoke main body 53. In other words, each boundary portion (the section where the magnetic polarity changes) between a pair of the magnetic poles 74a, 74b that are adjacent to each other in the circumferential direction of the yoke main body 53 is located in a corresponding one of the permanent magnets 71 to 73. Additionally, two of the boundary surfaces, each of which is located between a pair of the permanent magnets 71 to 73 that are adjacent to each other in the circumferential direction of the yoke main body 53, are each included in a corresponding one of the magnetic poles 74a, 74b.

In FIG. 5(b), the arrows show the directions of the vibration of the stator. The vibration is excited in the stator as shown in FIG. 5(b) in accordance with the operation of the direct current electric motor, that is, the rotation of the armature. The vibration sets, as antinodes, sections of the yoke main body 53 corresponding to the middle points each located between the end of the magnetic pole 74a and the end of the magnetic pole 74b that are adjacent to each other in the circumferential direction of the yoke main body 53, and as nodes, sections of the yoke main body 53 each corresponding to the center point of one of the magnetic poles 74a, 74b in the circumferential direction of the yoke main body 53. In the third embodiment, a section of the yoke main body 53 corresponding to one of the middle points each located between the end of the magnetic pole 74a and the end of the magnetic pole 74b that are adjacent to each other in the circumferential direction of the yoke main body 53 is reinforced by the permanent magnet 72 against the antinode of the vibration excited in the stator. Therefore, the vibration excited in the stator is suppressed.

The third embodiment provides the advantages that are the same as the advantages (1) to (5), (8) and (9) of the first embodiment.

A fourth embodiment of the present invention will now be described with reference to FIG. 6. A direct current electric motor of the fourth embodiment differs from the direct current electric motor 50 of the first embodiment in that the number of the permanent magnets is not three but four. The differences from the first embodiment will mainly be discussed below, and explanations of components that are like or the same as the components of the first embodiment are omitted.

FIG. 6 is a schematic diagram of a stator of the direct current electric motor according to the fourth embodiment for showing the arrangement of magnetic poles 79a, 79b with respect to permanent magnets 75, 76, 77, and 78. As shown in FIG. 6, four permanent magnets 75 to 78 are secured to the inner circumferential surface of the yoke main body 53. The permanent magnets 75 to 78 each have an arcuate cross-section, and the lengths of the permanent magnets 75 to 78 in the circumferential direction of the yoke main body 53 are equal to one another. The permanent magnets 75 to 78 are secured to the inner circumferential surface of the yoke main body 53 such that the permanent magnets 75 to 78 lie continuously along the entire circumference of the yoke main body 53, thereby forming a ring.

The magnetic polarity of one end of the permanent magnets 75 to 78 in the circumferential direction of the yoke main body 53 differs from that of the other end of the permanent magnets 75 to 78 in the circumferential direction of the yoke main body 53. More specifically, one end of the permanent magnets 75 to 78 in the circumferential direction of the yoke main body 53 forms first polarized portion 75a, 76a, 77b, and 78b, which have the characteristics of the S pole, and the other end of the permanent magnets 75 to 78 in the circumferential direction of the yoke main body 53 forms second polarized portions 75b, 76b, 77a, and 78a, which have the characteristics of the N pole.

Therefore, as shown in FIG. 6, the permanent magnets 75 to 78 include the S magnetic pole 79a, which includes the polarized portion 75a, the S magnetic pole 79a, which includes the polarized portion 78b, and the S magnetic pole 79a, which includes the polarized portions 76a, 77b, and the N magnetic pole 79b, which includes the polarized portion 76b, the N magnetic pole 79b, which includes the polarized portion 77a, and the N magnetic pole 79b, which includes the polarized portions 75b, 78a. The magnetic poles 79a, 79b are arranged at intervals of 60° from each other along the circumferential direction of the yoke main body 53. In this regard, however, the polarities of a pair of the magnetic poles 79a, 79b adjacent to each other in the circumferential direction of the yoke main body 53 are different from each other. In other words, the S magnetic poles 79a and the N magnetic poles 79b are alternately arranged in the circumferential direction of the yoke main body 53. The thicknesses of the magnetic poles 79a, 79b in the radial direction of the yoke main body 53, that is, the thicknesses of the permanent magnets 75 to 78 in the radial direction of the yoke main body 53 are equal to one another. The magnetic flux densities of the magnetic poles 79a, 79b are also equal to one another. As described above, the stator includes six magnetic poles 79a, 79b of alternating polarity arranged at intervals of 60° along the circumferential direction of the yoke main body 53.

In FIG. 6, among the straight-line segments that extend in the radial direction of the yoke main body 53, the straight-line segments each passing through the boundary surface between a pair of the permanent magnets 75 to 78 that are adjacent to each other in the circumferential direction of the yoke main body 53 are indicated by solid lines, and the straight-line segments each passing through the boundary surface (the section where the magnetic polarity changes) between a pair of the magnetic poles 79a, 79b that are adjacent to each other in the circumferential direction of the yoke main body 53 are indicated by broken lines. As shown in FIG. 6, each permanent magnet 75 to 78 includes sections that have different magnetic polarities from each other and that are adjacent to each other in the circumferential direction of the yoke main body 53. In other words, four of the boundary surfaces (the sections where the magnetic polarity changes), each of which is located between a pair of the magnetic poles 79a, 79b that are adjacent to each other in the circumferential direction of the yoke main body 53, are each located in a corresponding one of the permanent magnets 75 to 78. Two of the boundary surfaces, each of which is located between a pair of the permanent magnets 75 to 78 that are adjacent to each other in the circumferential direction of the yoke main body 53, are each located in a corresponding one of the magnetic poles 79a, 79b.

The vibration is excited in the stator (see FIG. 3(b)) in accordance with the operation of the direct current electric motor, that is, the rotation of the armature 52. The vibration sets, as antinodes, sections of the yoke main body 53 each corresponding to the boundary surface between a pair of the magnetic poles 79a, 79b that are adjacent to each other in the circumferential direction of the yoke main body 53, and as nodes, sections of the yoke main body 53 each corresponding to the center point of one of the magnetic poles 79a, 79b in the circumferential direction of the yoke main body 53. In the fourth embodiment, sections of the yoke main body 53 corresponding to four of the boundary surfaces, each of which is located between a pair of the magnetic poles 79a, 79b that are adjacent to each other in the circumferential direction of the yoke main body 53, are each reinforced by a corresponding one of the permanent magnets 75 to 78 against the antinode of the vibration excited in the stator. Therefore, the vibration excited in the stator is suppressed.

The fourth embodiment provides the following advantages in addition to the advantages that are the same as the advantages (1), (3) to (5), and (9) of the first embodiment.

(1) Since the number of the magnetic poles of the permanent magnets 75 to 78 is six, the number of the sections where the magnetic polarity changes is also six. On the other hand, the number of the permanent magnets. 75 to 78 is four, which is not a divisor of the number of the sections where the magnetic polarity changes. Therefore, at least one of the permanent magnets 75 to 78 is provided with the section where the magnetic polarity changes. Therefore, the vibration excited in the stator is suppressed by a very simple configuration.

A fifth embodiment of the present invention will now be described with reference to FIGS. 7(a) and 7(b). Accordingly, differences from the first embodiment will mainly be discussed below, and explanations of components that are like or the same as the components of the first embodiment are omitted.

FIG. 7(a) shows the arrangement of permanent magnets 96, 97, 98, and FIG. 7(b) shows the arrangement of magnetic poles 99a, 99b formed in the permanent magnets 96 to 98. As shown in FIGS. 7(a) and 7(b), three permanent magnets 96 to 98 are secured to the inner circumferential surface of the yoke main body at intervals of 120°. The permanent magnets 96 to 98 each have an arcuate cross-section, and the lengths of the permanent magnets 96 to 98 are equal to one another in the circumferential direction of the yoke main body.

The magnetic polarity of the middle section of the permanent magnets 96 to 98 in the circumferential direction of the yoke main body differs from the magnetic polarity of the end sections of the permanent magnets 96 to 98 in the circumferential direction of the yoke main body. More specifically, the middle section of the permanent magnets 96 to 98 in the circumferential direction of the yoke main body has the characteristics of the S pole, and the ends of the permanent magnets 96 to 98 in the circumferential direction of the yoke main body have the characteristics of the N pole. The angular dimension of the middle section of the permanent magnets 96 to 98 in the circumferential direction of yoke main body is 60°, and the angular dimension of the ends of the permanent magnets 96 to 98 in the circumferential direction of the yoke main body is 30° each. Therefore, as shown in FIG. 7(b), the three S magnetic poles 99a and the three N magnetic poles 99b are alternately arranged along the circumferential direction of the yoke main body at intervals of 60°. The thicknesses of the magnetic poles 99a, 99b in the radial direction of the yoke main body, that is, the thicknesses of the permanent magnets 96 to 98 in the radial direction of the yoke main body are equal to one another. The magnetic flux densities of the magnetic poles 99a, 99b are also equal to one another.

The boundary portions, which are boundary surfaces BL1, each located between a pair of the magnetic poles 99a, 99b that are adjacent to each other in the circumferential direction of the yoke main body each include a section that intersects the axis of the yoke main body. Furthermore, each boundary surface BL1 has a middle section in the axial direction of the yoke main body and end sections in the axial direction of the yoke main body. Each middle section is displaced from the corresponding end sections in the circumferential direction of the yoke main body, and each boundary surface BL1 is axisymmetrical with respect to a plane O, which divides the permanent magnets 96 to 98 (the magnetic poles 99a, 99b) into two along the axial direction of the yoke main body. The yoke main body is preferably flattened cylindrical shape to effectively suppress occurrence of cogging. However, if the yoke main body is cylindrical, it is effective to form the magnetic poles 99a, 99b on the permanent magnets 96 to 98 such that the boundary surfaces each located between a pair of the magnetic poles 99a, 99b that are adjacent to each other in the circumferential direction of the yoke main body each include a section that intersects the axis of the yoke main body.

The fifth embodiment provides the following advantages in addition to the advantages (1) to (5) and (7) to (9) of the first embodiment.

(1) The magnetic poles 99a, 99b are formed in the permanent magnets 96 to 98 such that the boundary surfaces each located between a pair of the magnetic poles 99a, 99b that are adjacent to each other in the circumferential direction of the yoke main body each include the section that intersects the axis of the yoke main body. In other words, the magnetic poles 99a, 99b are formed in the permanent magnets 96 to 98 through a skewed polarization. This suppresses cogging.

(2) The boundary surfaces BL1 each have the middle section in the axial direction of the yoke main body, and end sections in the axial direction of the yoke main body. Each middle section is displaced from the corresponding end sections in the circumferential direction of the yoke main body, and each boundary surface BL1 is axisymmetrical with respect to a plane O, which divides the permanent magnets 96 to 98 into two along the axial direction of the yoke main body. Thus, the magnetic function caused in accordance with the operation of the direct current electric motor suppresses the rotor from tilting with respect to the axis of the yoke main body.

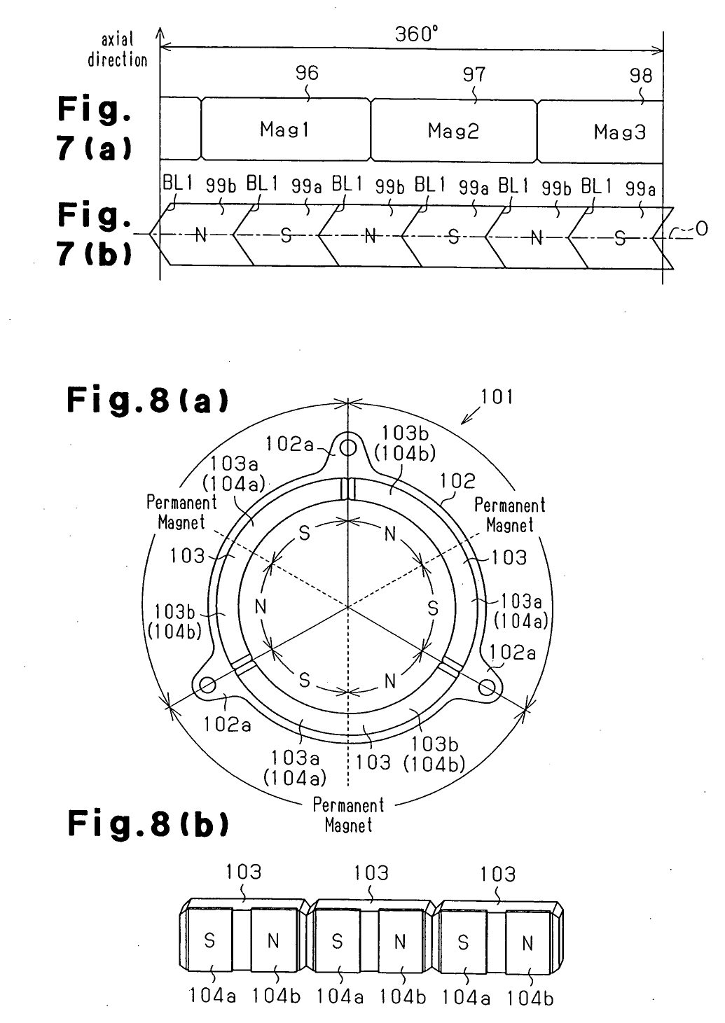

A sixth embodiment of the present invention will now be described with reference to FIGS. 8(a) and 8(b). Accordingly, differences from the first embodiment will mainly be discussed below, and explanations of components that are like or the same as the components of the first embodiment are omitted.

FIGS. 8(a) and 8(b) show the arrangement of magnetic poles 104a, 104b with respect to permanent magnets 103. As shown in FIG. 8(a), a stator 101 of the direct current electric motor according to the sixth embodiment includes a cylindrical yoke main body 102, three permanent magnets 103 secured to the inner circumferential surface of the yoke main body 102 at intervals of 120°. Three projections 102a that extend radially outward from the yoke main body 102 are formed on the yoke main body 102 at intervals of 120° along the circumferential direction of the yoke main body 102. The projections 102a are used for installing the stator 101 (the direct current electric motor) to an external device, or the like.

The permanent magnets 103 each have an arcuate cross-section, and the lengths of the permanent magnets 103 in the circumferential direction of the yoke main body 102 are equal to one another. The permanent magnets 103 are secured to the inner circumferential surface of the yoke main body 102 such that the permanent magnets 103 lie continuously along the entire circumference of the yoke main body 102, thereby forming a ring. The boundary surfaces each located between a pair of the permanent magnets 103 that are adjacent to each other in the circumferential direction of the yoke main body 102 are arranged such that each boundary is aligned with a corresponding one of the projections 102a in the circumferential direction of the yoke main body 102.

The magnetic polarity of half of each permanent magnet 103 in the circumferential direction of the yoke main body 102 is different from that of the other half. More specifically, half of the permanent magnets 103 in the circumferential direction of the yoke main body 102 forms first polarized portions 103a, which have the characteristics of the S pole, and the other half of the permanent magnets 103 in the circumferential direction of the yoke main body 102 forms second polarized portions 103b, which have the characteristics of the N pole. The angular dimension of the permanent magnets 103 in the circumferential direction of the yoke main body 102 is 120°, and the angular dimension of the polarized portions 103a, 103b in the circumferential direction of the yoke main body 102 is 60°. As shown in FIG. 8(a), the three first polarized portions 103a and the three second polarized portions 103b are alternately arranged along the circumferential direction of the yoke main body 102 at intervals of 60°, and the first polarized portions 103a function as the S magnetic poles 104a, while the second polarized portions 103b function as the N magnetic poles 104b. The thicknesses of the magnetic poles 104a, 104b in the radial direction of the yoke main body 102, that is, the thicknesses of the permanent magnets 103 in the radial direction of the yoke main body 102 are equal to one another. In addition, the magnetic flux densities of the magnetic poles 104a, 104b are also equal to one another. As described above, the stator 101 includes the six magnetic poles 104a, 104b of alternating polarity arranged at intervals of 60° along the circumferential direction of the yoke main body 102.

In FIG. 8(a), among the straight-line segments that extend in the radial direction of the yoke main body 102, the straight-line segments each passing through the boundary surface between a pair of the permanent magnets 103 that are adjacent to each other in the circumferential direction of the yoke main body 102 are indicated by solid lines, and straight-line segments each passing through the boundary surface (the section where the magnetic polarity changes) between a pair of the magnetic poles 104a, 104b that are adjacent to each other in the circumferential direction of the yoke main body 102 are indicated by broken lines. As shown in FIG. 8(a), each permanent magnet 103 includes sections that have different magnetic polarities from each other and that are adjacent to each other in the circumferential direction of the yoke main body 102. In other words, three of the boundary surfaces, each of which is located between a pair of the magnetic poles 104a, 104b that are adjacent to each other in the circumferential direction of the yoke main body 102, are each located in a corresponding one of the permanent magnets 103. The remaining three of the boundary surfaces each coincide with the boundary surface between a corresponding pair of the permanent magnets 103 that are adjacent to each other in the circumferential direction of the yoke main body 102. That is, the boundary surface at which the magnetic polarity changes from the N pole to the S pole clockwise as viewed in FIG. 8(a) is located in a corresponding one of the permanent magnets 103, and the boundary surface at which the magnetic polarity changes from the S pole to the N pole clockwise as viewed in FIG. 8(a) coincides with the boundary surface between a corresponding pair of the permanent magnets 103 that are adjacent to each other in the circumferential direction of the yoke main body 102.

The sixth embodiment provides the following advantages in addition to the advantages (2) to (4), (8) and (9) of the first embodiment.

(1) Three of the boundary surfaces, each of which is located between a pair of the magnetic poles 104a, 104b that are adjacent to each other in the circumferential direction of the yoke main body 102, are each located in a corresponding one of the permanent magnets 103. Therefore, sections of the yoke main body 102 corresponding to the boundary surfaces each located between a pair of the magnetic poles 104a, 104b that are adjacent to each other in the circumferential direction of the yoke main body 102 are reinforced by a corresponding one of the permanent magnets 103 against the antinode of the vibration excited in the stator 101 in accordance with the operation of the direct current electric motor, that is, the rotation of the armature. Therefore, the vibration excited in the stator 101 is suppressed.

The remaining three of the boundary surfaces, each of which is located between a pair of the magnetic poles 104a, 104b that are adjacent to each other in the circumferential direction of the yoke main body 102, each coincide with the boundary surface between a corresponding pair of the permanent magnets 103 that are adjacent to each other in the circumferential direction of the yoke main body 102. This prevents decrease of the amount of magnetic flux, which is likely to occur if all the boundary surfaces between the magnetic poles 104a, 104b are each located in a corresponding one of the permanent magnets 103.

(2) The boundary surfaces, each of which is located between a pair of the permanent magnets 103 that are adjacent to each other in the circumferential direction of the yoke main body 102, are each arranged to be aligned with a corresponding one of the projections 102a in the circumferential direction of the yoke main body 102. Thus, the rigidity of the yoke main body 102 is further increased, thereby suppressing the vibration excited in the stator 101.

The above embodiments may be modified as follows.

In the electric motor 50 of the first embodiment, the lengths of the polarized portions 54b, 54c of the permanent magnet 54 in the circumferential direction of the yoke main body 53 may differ from each other.

In the electric motor 50 of the first embodiment, the magnetic polarity of half of the permanent magnets 54 in the circumferential direction of the yoke main body 53 may be different from that of the other half of the permanent magnets 54 in the circumferential direction of the yoke main body 53.

In the stator of the second embodiment, only two polarized portions having different magnetic polarities from each other may be formed in the permanent magnet 67 in addition to the permanent magnets 66, 68.

In the fourth embodiment, the permanent magnets 75 to 78 may be provided with three polarized portions of alternating polarity in the circumferential direction of the yoke main body 53.

In the fifth embodiment, on the assumption that the permanent magnets 96, 97, 98 are arranged as shown in FIG. 9(a), the boundary surfaces BL1 each located between a pair of the magnetic poles 99a, 99b that are adjacent to each other in the circumferential direction of the yoke main body may be replaced with, for example, any of the boundary surfaces BL2 to BL5 shown in FIGS. 9(b) to 9(e).

The boundary surfaces BL2 shown in FIG. 9(b) are each formed of a plane that intersects with a plane O, which divides the permanent magnets 96 to 98 in the axial direction of the yoke main body, and the axis of the yoke main body. According to the modified embodiment of FIG. 9(b), the advantages that are the same as the advantages of the fifth embodiment except the advantage (2) are achieved. The boundary surfaces BL3 shown in FIG. 9(c) are each formed of curved surface having the crest located on the plane O. The boundary surfaces BL4 shown in FIG. 9(d) each have a step-like shape where only part of the boundary surfaces BL4 that includes a cross line that intersects with the plane O projects in the circumferential direction of the yoke main body. The boundary lines BL5 shown in FIG. 9(e) are designed such that the middle section of the boundary lines BL5 in the axial direction of the yoke main body extends along the axis of the yoke main body, and the end sections of the boundary lines BL5 in the axial direction of the yoke main body incline with respect to the axis of the yoke main body. According to the modified embodiment of FIGS. 9(c) to 9(e), the advantages that are the same as those of the fifth embodiment are achieved.

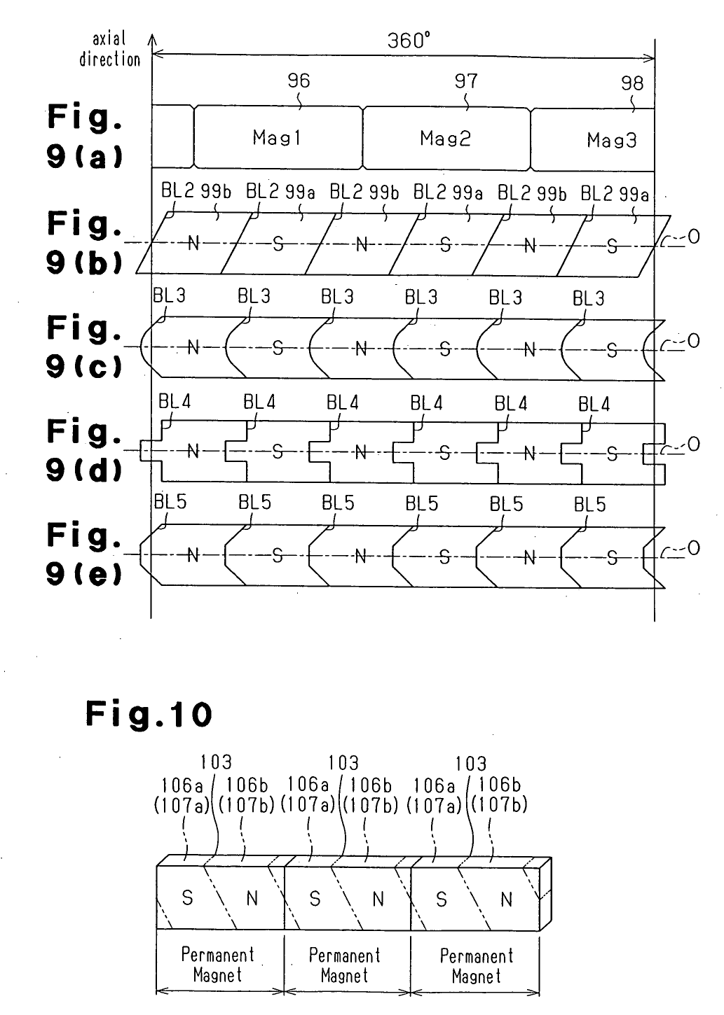

In the sixth embodiment, the magnetic poles 104a, 104b may be formed in the permanent magnets 103 through a skewed polarization. More specifically, for example, as shown in FIG. 10, polarized portions 106a, 106b may be formed in the permanent magnets 103 such that the boundary portions each located between a pair of the magnetic poles 107a, 107b that are adjacent to each other in the circumferential direction of the yoke main body 102 each intersect the axis of the yoke main body 102. According to the above mentioned modified embodiment, cogging is suppressed.

In the first to fifth embodiment, projections that extend radially outward of the yoke main body may be formed on the yoke main body. The projections are preferably arranged such that each projection is aligned, in the circumferential direction of the yoke main body, with the boundary surface between a pair of the permanent magnets that are adjacent to each other in the circumferential direction of the yoke main body.

In each of the above embodiments, the lengths of the permanent magnets in the circumferential direction of the yoke main body are equal to one another. However, at least one permanent magnet the length of which in the circumferential direction of the yoke main body is different from that of the others may be included. In this case, the permanent magnets are secured to the inner circumferential surface of the yoke main body at unequal intervals along the circumferential direction of the yoke main body. In this regard, however, since the polarity of the magnetic poles formed in the permanent magnets alternately change at equal intervals along the circumferential direction of the yoke main body, the sections where the magnetic polarity changes exist at equal intervals along the circumferential direction of the yoke main body. Therefore, at least one of the permanent magnets is provided with the section where the magnetic polarity changes, and the vibration excited in the stator is suppressed with a very simple configuration.

In each of the above embodiments, the polarity of the magnetic poles formed in the permanent magnets may be reversed.

In each of the above embodiments, the stator may include any number of permanent magnets as long as the stator includes more than one permanent magnet. Likewise, the stator may include any number of magnetic poles as long as the stator includes an even number of the magnetic poles. Moreover, the number of the permanent magnets and the number of the magnetic poles may be the same as or different from each other.

In the armature that includes a coil formed through a concentrated winding of a wire about teeth, the following points should be taken into consideration regarding the relationship between the number of the magnetic poles (the angular dimension of the magnetic poles) and the number of the slots (the angular dimension between the adjacent teeth). For example, the angular dimensions of the magnetic poles and the slots should not differ by an amount that causes the angular dimension range of a single magnetic pole to include two teeth, or the angular dimension range between a pair of adjacent teeth to include two magnetic poles. More specifically, the number of the magnetic poles and the slots need to be set to satisfy the following inequality on the assumption that the number of the magnetic poles is represented by M, and the number of the slots is represented by S.

When M<S, 360/2M<360/S<360/M and when M>S, 360/M<360/S<2×360/M

The number of the magnetic poles and the slots may be set on an as required basis within the range that satisfies the above relationship.

Even if the angular dimensions of the permanent magnets and the magnetic poles slightly increase or decrease due to manufacturing error, such variations are not to be considered as a deviation from the scope of the present invention.

1. An electric motor, comprising:
a cylindrical yoke main body; and
a plurality of permanent magnets having an arcuate cross-section, the permanent magnets are secured to a circumferential surface of the yoke main body such that the permanent magnets are continuous with one another along the entire circumference of the yoke main body, thereby forming a ring, wherein an even number of magnetic poles are formed in the permanent magnets at predetermined angular intervals along the circumferential direction of the yoke main body, a pair of the magnetic poles that are adjacent to each other in the circumferential direction of the yoke main body have different magnetic polarities from each other, and at least one of the permanent magnets is provided with a section where the magnetic polarity changes in the circumferential direction of the yoke main body.

2. The electric motor according to claim 1, wherein the boundary surface between the at least one permanent magnet and at least one of two permanent magnets that are adjacent to the at least one permanent magnet in the circumferential direction of the yoke main body is located in a corresponding one of the magnetic poles.

3. The electric motor according to claim 2, wherein the boundary surfaces each located between a pair of the permanent magnets that are adjacent to each other in the circumferential direction of the yoke main body are each located at the middle point of the corresponding one of the magnetic poles in the circumferential direction of the yoke main body.

4. The electric motor according to claim 2, wherein, when the number of the permanent magnets is represented by X, the number of the magnetic poles is 2X, the magnetic polarity of the middle section of each permanent magnet in the circumferential direction of the yoke main body differs from the magnetic polarity of the end sections of the permanent magnet in the circumferential direction of the yoke main body, and the angular dimension of the middle section of each permanent magnet in the circumferential direction of the yoke main body is 360/2X degrees.

5. The electric motor according to claim 4, wherein the angular dimension of the end sections of each permanent magnet in the circumferential direction of the yoke main body is 360/4X degrees each.

6. The electric motor according to claim 1, wherein the lengths of the permanent magnets in the circumferential direction of the yoke main body are equal to one another.

7. The electric motor according to claim 1, wherein the length of at least one of the permanent magnets differs from the length of another one of the permanent magnets in the circumferential direction of the yoke main body.

8. The electric motor according to claim 1, wherein the number of the permanent magnets is different from the divisor of the number of the magnetic poles.

9. The electric motor according to claim 1, further comprising an armature located on the inner side of the permanent magnets, the armature including a plurality of teeth extending in the radial direction of the yoke main body, coils formed by winding a wire about the teeth through a concentrated winding, a commutator to which the ends of the coils are connected, and brushes, which supply electric power to the coils through the commutator.

10. The electric motor according to claims 1, wherein at least one of the boundary surfaces each located between a pair of the permanent magnets that are adjacent to each other in the circumferential direction of the yoke main body coincides with a section where the magnetic polarity changes in the circumferential direction of the yoke main body.

11. The electric motor according to claim 10, wherein boundary portions each located between a pair of the magnetic poles that are adjacent to each other in the circumferential direction of the yoke main body each have a first section and a second section that are displaced from each other in the axial direction of the yoke main body, and each first section is displaced from the corresponding second section in the circumferential direction of the yoke main body.

12. The electric motor according to claims 1, wherein boundary portions each located between a pair of the magnetic poles that are adjacent to each other in the circumferential direction of the yoke main body each have a first section and a second section that are displaced from each other in the axial direction of the yoke main body, and each first section is displaced from the corresponding second section in the circumferential direction of the yoke main body.

13. The electric motor according to claim 1, wherein boundary portion each located between a pair of the magnetic poles that are adjacent to each other in the circumferential direction of the yoke main body each have a middle section in the axial direction of the yoke main body and end sections in the axial direction of the yoke main body, and each middle section is displaced from the corresponding end sections in the circumferential direction of the yoke main body.

14. The electric motor according to claim 1, wherein the yoke main body includes a plurality of projections extending radially outward of the yoke main body, at least one of the boundary surfaces each located between a pair of the permanent magnets that are adjacent to each other in the circumferential direction of the yoke main body is arranged to be aligned with a corresponding one of the projections in the circumferential direction of the yoke main body.

15. An electric motor, comprising:
a cylindrical yoke main body; and
a plurality of permanent magnets having an arcuate cross-section, the permanent magnets are secured to a circumferential surface of the yoke main body such that the permanent magnets are continuous with one another along the entire circumference of the yoke main body, thereby forming a ring, wherein the magnetic polarity of the middle section of each permanent magnet in the circumferential direction of the yoke main body differs from the magnetic polarity of the end sections of the permanent magnet in the circumferential direction of the yoke main body.

16. The electric motor according to claim 15, wherein the lengths of the permanent magnets in the circumferential direction of the yoke main body are equal to one another.

17. The electric motor according to claim 15, wherein the length of at least one of the permanent magnets differs from the length of another one of the permanent magnets in the circumferential direction of the yoke main body.

18. The electric motor according to claim 15, wherein the number of the permanent magnets is different from the divisor of the number of the magnetic poles.

19. The electric motor according to claim 15, further comprising an armature located on the inner side of the permanent magnets, the armature including a plurality of teeth extending in the radial direction of the yoke main body, coils formed by winding a wire about the teeth through a concentrated winding, a commutator to which the ends of the coils are connected, and brushes, which supply electric power to the coils through the commutator.

20. The electric motor according to claim 15, wherein at least one of the boundary surfaces each located between a pair of the permanent magnets that are adjacent to each other in the circumferential direction of the yoke main body coincides with a section where the magnetic polarity changes in the circumferential direction of the yoke main body.

21. The electric motor according to claim 20, wherein boundary portions each located between a pair of the magnetic poles that are adjacent to each other in the circumferential direction of the yoke main body each have a first section and a second section that are displaced from each other in the axial direction of the yoke main body, and each first section is displaced from the corresponding second section in the circumferential direction of the yoke main body.

22. The electric motor according to claim 15, wherein the boundary portions each located between a pair of the magnetic poles that are adjacent to each other in the circumferential direction of the yoke main body each have a first section and a second section that are displaced from each other in the axial direction of the yoke main body, and each first section is displaced from the corresponding second section in the circumferential direction of the yoke main body.

23. The electric motor according to claim 15, wherein the boundary portions each located between a pair of the magnetic poles that are adjacent to each other in the circumferential direction of the yoke main body each have a middle section in the axial direction of the yoke main body and end sections in the axial direction of the yoke main body, and each middle section is displaced from the corresponding end sections in the circumferential direction of the yoke main body.

24. The electric motor according to claims 15, wherein the yoke main body includes a plurality of projections extending radially outward of the yoke main body, at least one of the boundary surfaces each located between a pair of the permanent magnets that are adjacent to each other in the circumferential direction of the yoke main body is arranged to be aligned with a corresponding one of the projections in the circumferential direction of the yoke main body.

25. An electric motor, comprising:
a cylindrical yoke main body; and
an odd number of permanent magnets the number of which is greater than or equal to three, the permanent magnets having an arcuate cross-section, the permanent magnets are secured to a circumferential surface of the yoke main body such that the permanent magnets are continuous with one another along the entire circumference of the yoke main body, thereby forming a ring, wherein the lengths of the permanent magnets in the circumferential direction of the yoke main body are equal to one another, even numbers of magnetic poles are formed in the permanent magnets along the circumferential direction of the yoke main body at predetermined angular intervals from one another, and a pair of the magnetic poles that are adjacent to each other in the circumferential direction of the yoke main body have different magnetic polarities from each other.

26. The electric motor according to claim 25, wherein the number of the permanent magnets is three.

27. The electric motor according to claim 25, wherein the number of the permanent magnets is different from the divisor of the number of the magnetic poles.

28. The electric motor according to claim 25, further comprising an armature located on the inner side of the permanent magnets, the armature including a plurality of teeth extending in the radial direction of the yoke main body, coils formed by winding a wire about the teeth through a concentrated winding, a commutator to which the ends of the coils are connected, and brushes, which supply electric power to the coils through the commutator.

29. The electric motor according to claim 25, wherein at least one of the boundary surfaces each located between a pair of the permanent magnets that are adjacent to each other in the circumferential direction of the yoke main body coincides with a section where the magnetic polarity changes in the circumferential direction of the yoke main body.

30. The electric motor according to claim 29, wherein boundary portions each located between a pair of the magnetic poles that are adjacent to each other in the circumferential direction of the yoke main body each have a first section and a second section that are displaced from each other in the axial direction of the yoke main body, and each first section is displaced from the corresponding second section in the circumferential direction of the yoke main body.

31. The electric motor according to claim 25, wherein boundary portions each located between a pair of the magnetic poles that are adjacent to each other in the circumferential direction of the yoke main body each have a first section and a second section that are displaced from each other in the axial direction of the yoke main body, and each first section is displaced from the corresponding second section in the circumferential direction of the yoke main body.

32. The electric motor according to claim 25, wherein boundary portions each located between a pair of the magnetic poles that are adjacent to each other in the circumferential direction of the yoke main body each have a middle section in the axial direction of the yoke main body and end sections in the axial direction of the yoke main body, and each middle section is displaced from the corresponding end sections in the circumferential direction of the yoke main body.

33. The electric motor according to claim 25, wherein the yoke main body includes a plurality of projections extending radially outward of the yoke main body, at least one of the boundary surfaces each located between a pair of the permanent magnets that are adjacent to each other in the circumferential direction of the yoke main body is arranged to be aligned with a corresponding one of the projections in the circumferential direction of the yoke main body.
